(19) United States
(12) Patent Application Publication
(10) Pub. No.: US 2004/0046969 A1
(43) Pub. Date: Mar. 11, 2004

(54) System and method for monitoring thin film deposition on optical substrates

(75) Inventor: Carl D. Anderson, Prior Lake, MN (US)

Correspondence Address: Dennis C. Bremer, Honeywell International, Inc., 101 Columbia Road, P.O. Box 2245, Morristown, NJ, 07962-2245, US

(73) Assignee: Honeywell International Inc., Morristown, NJ

(21) Appl. No.: 10/238,225

(22) Filed: Sep. 10, 2002

(51) Int. Cl. G01B 11/28

(52) U.S. Cl. 356/630

(57) ABSTRACT

By providing an optical monitor in a coating chamber that can continuously monitor layer thickness of thin films deposited on optical substrates during thin film deposition, optical coatings may be uniformly produced in high volumes. The optical monitor includes a light source, a light detector, a control panel, and a computer. The light source generates a light beam that is directed into the coating chamber towards the optical substrates. When the light beam hits the optical substrates, an amount of light passes through. The amount of light that passes through the optical substrates is representative of the thin film layer thickness on the substrates. The detector detects the amount of light that passes through and generates a current signal. The control panel converts the current signal to a voltage signal and provides transmission data to the computer. The computer calculates the thickness of the thin film layer using the transmission data and provides correction information.

### FIELD

The present invention relates generally to thin film deposition on optical substrates, and more particularly, relates to monitoring and controlling layer thickness during thin film deposition.

### BACKGROUND

Optical coatings may be used in the production of laser mirrors, optical filters, and other devices. A series of thin film layers are deposited onto an optical substrate to produce the optical coatings. A variety of thin film deposition methods, such as chemical vapor deposition (CVD) and physical vapor deposition (PVD), may be used to deposit the layers onto the optical substrate. The number of layers deposited on the substrate depends on the desired characteristics of the optical coatings. For example, the optical coating for an optical interference filter may consist of hundreds of layers.

The thickness of each of those layers may be critical to the performance of the final product. Some optical coatings require a high degree of wavelength accuracy and may be fractions of a nanometer thick. When mass-producing the optical coatings, it may be difficult to maintain thickness uniformity for each of the layers needed to produce a consistent final product.

To achieve coating uniformity, the optical substrates may be mounted on a substrate holder, or “planet,” located in a vacuum coating chamber. The substrate holders may be located in the chamber on a mechanical carousel, termed the “planetary system.” The planetary system may have a central axis around which additional planets having a sub-axis can rotate. Each substrate holder rotates and revolves about the vacuum chamber, reaching speeds up to 2000 rotations per minute. As the substrates are rotating in the vacuum coating chamber, thin films may be deposited onto the substrates to form the coating. Many factors may affect the optical properties of the coating, such as vacuum quality, deposition rate, temperature, gas flows, and ion source characteristics.

Optical monitors may be used during the thin film deposition process to monitor and control the layer thickness. An optical monitor uses light to measure film thickness. Some optical monitors monitor the thin film deposition process on a witness or test glass, and not on the actual optical substrate in which the thin film is being applied. Witness glasses may be needed for applications in which light cannot pass through the substrate, such as applications requiring frosted coatings. However, optical monitors that monitor witness glasses are not as accurate as those monitoring the actual substrate, as the witness glass is not located in the same position as the actual optical substrates. As a result, the coating deposited on the actual optical substrates has different optical properties than the coating deposited on the witness glass.

Other optical monitors may monitor an actual substrate while it is stationary. While these systems can achieve good results, the results are limited to the single substrate located where the optical monitoring is occurring. Furthermore, the coating uniformity may be limited to a small area on the substrate since the substrate is stationary. These limitations make this type of optical monitor impractical for mass-production applications.

Therefore an optical monitor capable of continually monitoring the actual optical substrate, while the substrate is moving during thin film deposition, would be beneficial. Such an optical monitor could be used in mass-production applications that desire a uniform and repeatable final product.

### SUMMARY

A system and method for continuously monitoring layer thickness during thin film deposition of optical coatings is provided. A light source operable to generate a light beam is directed towards an optical substrate moving in a coating chamber. The light beam passes through the optical substrate and is detected by a detector. The detector is operable to detect light and provide an output representative of an amount of light detected. The amount of light detected is related to thickness of thin film layers deposited on the optical substrate. A control panel generates optical transmission data from the output representative of the amount of light detected by the detector.

### BRIEF DESCRIPTION OF THE DRAWINGS

Presently preferred embodiments are described below in conjunction with the appended drawing figures, wherein like reference numerals refer to like elements in the various figures, and wherein:

FIG. 1 is a block diagram of a coating system employing an optical monitor, according to an exemplary embodiment;

FIG. 2 is a graphical representation of a typical path of a substrate moving in a planetary system, according to an exemplary embodiment;

FIG. 3 is a block diagram of an optical monitor, according to an exemplary embodiment;

FIG. 4 is a graphical representation of an optical monitor signal, according to an exemplary embodiment; and

FIG. 5 is a flow chart of a method of monitoring thin film deposition of optical coatings, according to an exemplary embodiment.

### DETAILED DESCRIPTION

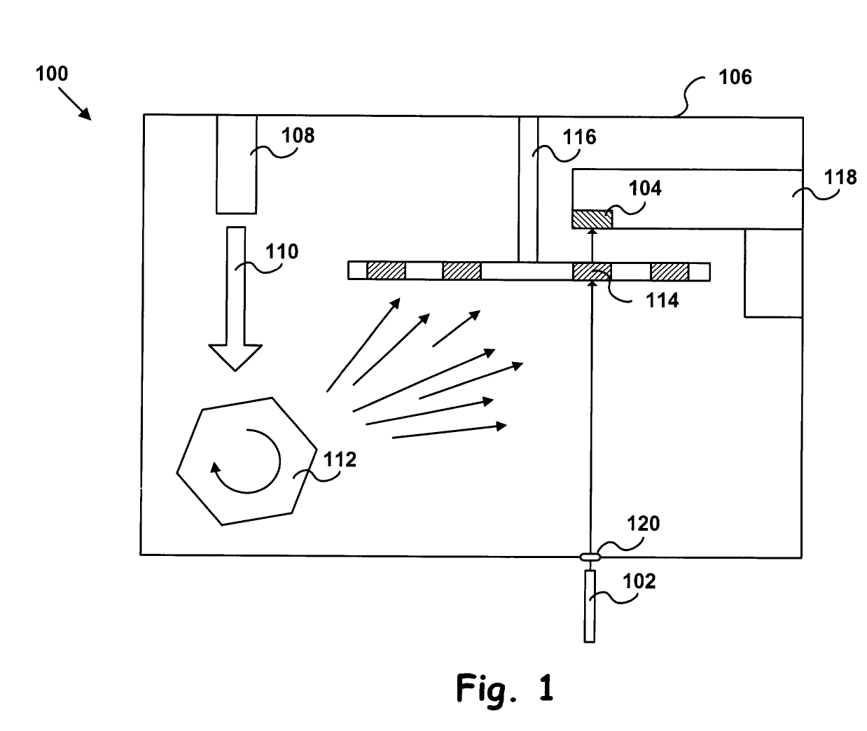

FIG. 1 is a block diagram of a coating system 100 employing an optical monitor according to an exemplary embodiment. The coating system 100 depicted in FIG. 1 illustrates ion beam sputter deposition, but any chemical or physical vapor deposition process may be used. For example, the thin film deposition process may be AC magnitron, RF sputtering, or Electron Beam processing.

The coating system 100 may include a coating chamber 106. The coating chamber 106 may be a vacuum chamber that includes the equipment needed to perform thin film deposition. In this example, an ion gun 108 may be used to provide a beam of ions 110. The ion gun 108 may direct the beam of ions 110 at a rotating or non-rotating ion target 112. The ion target 112 may be a grounded metallic or dielectric sputtering target. As the beam of ions 110 hits the ion target 112, material may be sputtered within the coating chamber 106. The material sputtered from the ion target 112 may be deposited on one or more substrates 114 forming a coating.

The one or more substrates 114 may be held on a substrate holder 116, also known as a “planet.” The substrate holder 116 may hold one or more substrates depending on the application. In this example, the substrate holder 116 is depicted in FIG. 1 as holding four substrates. However, the substrate holder 116 may hold more or less than four substrates.

The substrate holder 116 may be located in the coating chamber 106 on a mechanical carousel, known as a “planetary system.” The planetary system may provide single or dual axis rotation in the coating chamber 106. The planetary system rotates and revolves the substrates 114 in the coating chamber 106. The rotating and revolving of the substrates 114 while the material is being sputtered in the coating chamber 106 may cause a substantially similar thin film deposit on each of the one or more substrates 114 located on the substrate holder 116. While one substrate holder 116 is shown in FIG. 1, the coating chamber 106 may include more than one substrate holder, such as in a dual-axis planetary system.

As the coating is formed on the one or more substrates 114, a light source 102 may be directed towards the one or more substrates 114. A light beam from the light source 102 may be directed into the coating chamber 106 with an adjustable mirror or prism through a glass view-port 120. The adjustable mirror or prism is not shown in FIG. 1.

The adjustable mirror or prism may allow the light beam to be directed at different substrates 114 located on the substrate holder 116. The angle that the light beam makes with the substrate can be set to angles other than normal incidence. While near normal incidence is shown in FIG. 1, other angles may be used. The glass view-port 120 may be designed to minimize distortion of the light beam as it travels through the view-port 120 and enters into the coating chamber 106. Additionally, the glass view-port 120 may be positioned on a wall of the coating chamber 106 in a manner that minimizes deposition of sputtered material on the view-port 120.

The light beam may then pass through the one or more substrates 114. The amount of light that passes through the substrates 114 may be representative of the thickness of the thin film layers deposited on the substrates. A detector 104 held in the coating chamber 106 with a mounting fixture 118 may detect the light that passes through the one or more substrates 114.

The light source 102 may generate a monochromatic light beam; however, monochromatic light is not required. In a preferred embodiment, the light source 102 is a laser diode. For example, the light source 102 may be a laser diode designed to generate a light beam with a wavelength of substantially 635 nanometers at substantially 3 milliwatts. However, other sources of light and light beam characteristics may be used.

The detector 104 may be any device operable to detect light, such as a photodiode. In a preferred embodiment, the detector 104 is a photodiode with part to number PIN-44DI from UDT Sensors, Inc. However, other photodiodes or light detectors may also be used. The detector 104 may detect light and provide an output signal of current representative of the amount of light detected.

The detector 104 may be mounted inside the coating chamber 106 using the mounting fixture 118. The mounting fixture 118 may be a metal mounting post that is fastened to a coating chamber wall. The use of the metal mounting post may protect the detector 104 from excessive heat due to conduction in the coating chamber wall. Additionally, for thin film deposition processes that require high temperatures, the detector 104 may be water-cooled.

In an alternative embodiment, the detector 104 may be located outside the coating chamber provided that the light that passes through the one or more substrates 114 is directed out of the coating chamber 106 through a glass view-port using one or more mirrors or prisms. The glass view-port may be substantially the same as the glass viewExpress port 120 that allows the light beam from the light source 102 to enter the coating chamber 106.

In a preferred embodiment, the light source 102 and the detector 104 may be located away from the center of the coating chamber 106. While the light source 102 and the detector 104 may be placed in the center of the coating chamber 106, placing the light source 102 and the detector 104 towards the sides of the chamber 106 may result in more optical measurements, providing more control over the thin film deposition process.

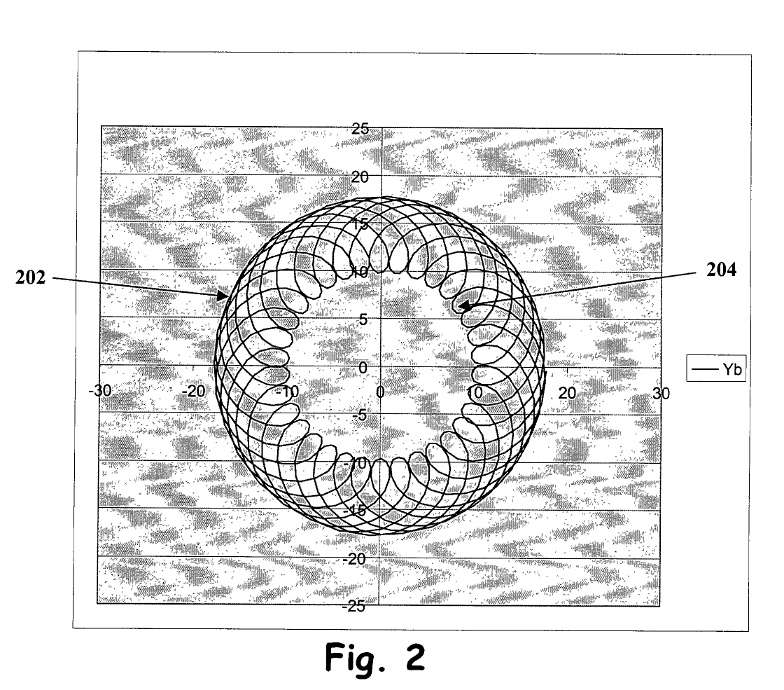

For example, FIG. 2 depicts a typical path of a substrate moving many times around the planetary system. Position 202 and position 204 represents two possible locations for the light source 102 and the detector 104 in the coating chamber 106. Other positions are possible. Position 202 is located away from the center of the coating chamber 106, while position 204 is located closer to the center of the coating chamber 106. As shown in FIG. 2, locating the light source 102 and the detector 104 at position 202 may result in the substrate crossing the light beam more frequently than at position 204.

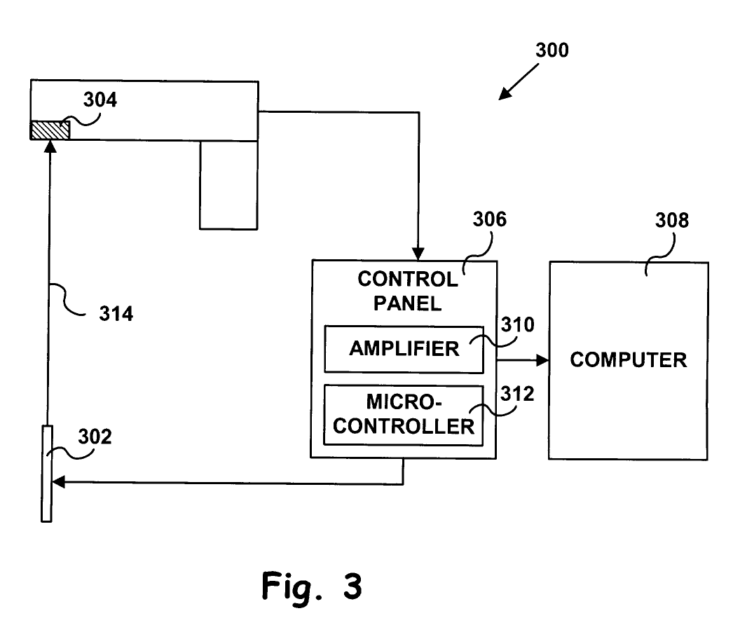

FIG. 3 is a block diagram of an optical monitor 300, according to an exemplary embodiment. The optical monitor 300 may monitor the deposition process of any thin film, and may be especially beneficial for monitoring the deposition of thin films used to produce optical coatings that require a high level of layer thickness accuracy. The coatings may include, but are not limited to, antireflective coatings, beam splitting coatings, notch filter coatings, and laser mirror coatings.

The optical monitor 300 may use optical transmission to take substantially continuous light measurements from a light beam 314 passing through the one or more substrates 114. The light measurements may be taken without moving the substrates 114 from where the substrates 114 are positioned during the deposition process. The optical monitor 300 may include a light source 302, a detector 304, a control panel 306, and a computer 308. The light source 302 may be substantially the same as the light source 102 as depicted in FIG. 1. The detector 304 may be substantially the same as the detector 104 as depicted in FIG. 1.

The control panel 306 may contain an amplifier 310 and a microcontroller 312. The amplifier 310 may be operable to convert the current signal from the output of the detector 304 into a voltage signal that can be measured. For example, the amplifier may be an operational amplifier or any other device capable of converting a current signal into a voltage signal.

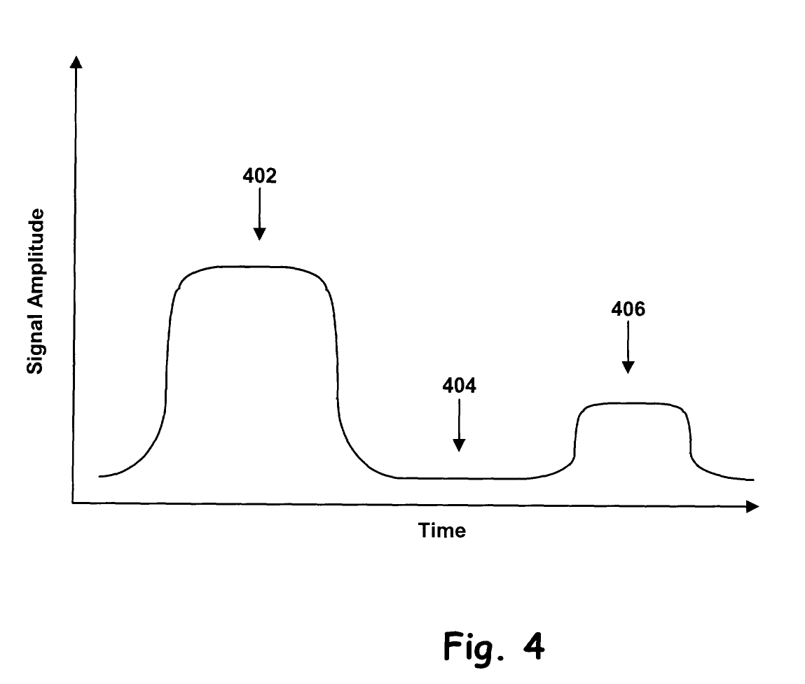

The voltage signal may then be processed by the microcontroller 312. An output of the microcontroller may be transmission data, which may be used to determine layer thickness. The microcontroller 312 may receive voltage signals from the amplifier 310 when the light beam 314 from the light source 302 is (1) unobstructed; (2) blocked by the substrate holder 116; or (3) passes through the one or more substrates 114. FIG. 4 provides a graphical representation of an optical monitor signal depicting the voltage levels representative of these three scenarios.

When the light beam 314 is unobstructed, the detector 304 may detect substantially a maximum amount of light. The light beam 314 may be unobstructed when the light beam 314 travels between moving substrate holders. The current signal generated by the detector 304 in response to the light beam 314 may be converted into a 100% reference signal 402 by the amplifier 310. The 100% reference signal 402 may represent the maximum amount of light that the optical monitor 300 is designed to detect. For example, the optical monitor 300 may be limited to detecting the maximum amount of light that the light source 302 can generate.

When the substrate holder 116 blocks the light beam 314, the detector 304 may detect substantially a minimum amount of light. The current signal generated by the detector 304 in response to the blockage may be converted into a stray light signal 404 by the amplifier 310. The stray light signal 404 may represent the background level of light in the coating chamber 106. The stray light signal 404 may be greater than zero volts due to background light. For example, the ion gun 108 may give off light in the coating chamber 106.

When the light beam 314 passes through the one or more substrates 114, the detector 304 may detect an amount of light that is representative of the thickness of the thin film layer on the substrate. The current signal generated by the detector 304 in response to amount of light passing through the substrate 114 may be converted into the transmission signal 406 by the amplifier 310. The transmission signal 406 may be used in calculating the layer thickness and controlling the deposition process.

The control panel 306 may also receive signals from position sensors located in the coating chamber 106. (The position sensors are not shown in FIG. 1.) The control panel 306 may transmit the optical monitor data and the position sensor data from the microcontroller 312 to the computer 308. For example, the microcontroller 312 may send data to the computer 308 on a periodic basis, such as every six seconds.

The computer 308 is shown in FIG. 3 as a stand-alone component of the optical monitor 300; however, the computer 308 may be co-located with the control panel 306. The computer 308 may be any combination of hardware, software, and firmware that is capable of generating layer thickness information from the data supplied by the control panel 306. For example, the computer 308 may be a main frame computer, a desk top computer, a lap top computer, or an integrated circuit.

The computer 308 may determine the optical properties of the deposited layers using the information obtained from the microcontroller 306 and known optical principles. The computer 308 may include analytical software capable of determining layer thickness, and comparing actual layer thickness to desired layer thickness. The computer 308 may display the results on a monitor or screen.

In addition, the computer 308 may provide correction information that may be used to adjust the thickness of a layer being deposited or subsequent layers. The correction information may take the form of different layer times or different process parameters, such as ion beam current or process gas flow amounts to use. The correction information may used to adjust the deposition process automatically. Alternatively, the correction information may be provided to an operator that can alter the deposition process in response to the information. The deposition process may be stopped earlier than expected or may continue for a longer period of time based on the correction information.

In an alternative embodiment, a witness glass may be monitored. The witness glass may be a test glass in which light can pass through. The witness glass may be needed for a frosted coating, an odd shaped substrate, or other applications in which the light beam 314 from the light source 302 cannot pass through the one or more substrates 114. The witness glass may be positioned on the substrate holder 116 in a location that would provide a representative thickness measurement of the one or more substrates 114.

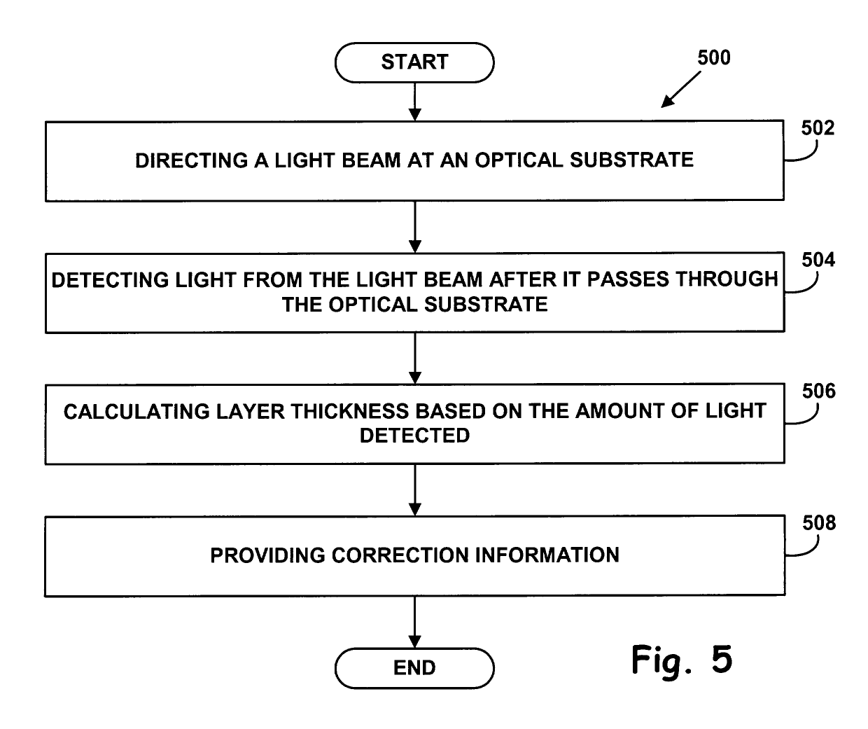

FIG. 5 is a flow chart of a method 500 of monitoring thin film deposition of optical coatings. Step 502 is directing a light beam at an optical substrate. Thin films may have been deposited on the optical substrate. Alternatively, the light beam may be directed at a witness glass. The light beam may be generated by a light source located outside the coating chamber. The light beam is directed into the coating chamber through a glass view-port using an adjustable mirror or prism.

Step 504 is detecting light from the light beam after it passes through the optical substrate. A detector, such as a photodiode, detects the light. The detector may also detect when the light beam is unobstructed and when the substrate holder blocks the light beam. The detector may generate a current signal that is representative of the amount of light detected.

Step 506 is calculating layer thickness based on the amount of light detected. The amount of light that passes through the optical substrate may be related to the thickness of the thin film layer deposited on the substrate. The current signal from the detector may be converted into a voltage signal that can be used to calculate the layer thickness.

Step 508 is providing correction information. Using the thickness data, the deposition process may be adjusted to alter the amount of material deposited on the thin film layer currently being deposited or the thickness of a layer to be deposited in future processing of the optical coating. The deposition process may be adjusted automatically or manually.

By providing an optical monitor in the coating chamber that can continuously monitor layer thickness on actual moving substrates during thin film deposition, optical coatings may be uniformly produced in high volumes. The deposition of the coatings may be monitored from start to finish, which is especially beneficial for critical coatings requiring a high degree of wavelength accuracy.

It should be understood that the illustrated embodiments are exemplary only and should not be taken as limiting the scope of the present invention. The claims should not be read as limited to the described order or elements unless stated to that effect. Therefore, all embodiments that come within the scope and spirit of the following claims and equivalents thereto are claimed as the invention.

We claim:

1. An optical monitor for continuously monitoring layer thickness during thin film deposition of optical coatings, comprising in combination:
a light source operable to generate a light beam, wherein the light beam is directed towards an optical substrate in a coating chamber;
a detector operable to detect light and provide an output representative of an amount of light detected, wherein the amount of light detected is related to thickness of thin film layers deposited on the optical substrate;
a control panel operable to generate optical transmission data from the output representative of the amount of light detected by the detector.

2. The system of claim 1, further comprising a computer operable to determine layer thickness using the optical transmission data obtained from the control panel.

3. The system of claim 2, wherein the computer provides correction information for adjusting thin film layer thickness.

4. The system of claim 1, wherein the light beam is directed into the coating chamber through a glass view-port using an adjustable mirror.

5. The system of claim 1, wherein the light beam is monochromatic.

6. The system of claim 1, wherein the light source is a laser diode.

7. The system of claim 6, wherein the laser diode generates a light beam with a wavelength of substantially 635 nanometers at substantially 3 milliwatts.

8. The system of claim 1, wherein the optical substrate is located on a substrate holder.

9. The system of claim 8, wherein the substrate holder is located in a planetary system.

10. The system of claim 9, wherein the planetary system provides single axis rotation in the coating chamber.

11. The system of claim 9, wherein the planetary system provides dual axis rotation in the coating chamber.

12. The system of claim 1, wherein the detector is a photodiode.

13. The system of claim 1, wherein the detector is mounted inside the coating chamber using a mounting fixture.

14. The system of claim 13, wherein the mounting fixture is a metal mounting post that is fastened to a wall of the coating chamber.

15. The system of claim 1, wherein the detector is located outside the coating chamber, wherein the light is directed out of the coating chamber through a glass viewport with at least one mirror.

16. The system of claim 1, wherein the output representative of the amount of light detected is a current signal.

17. The system of claim 16, wherein the control panel includes an amplifier operable to convert the current signal into a voltage signal.

18. The system of claim 17, wherein the control panel includes a microcontroller operable to receive voltage signals from the amplifier, and wherein the voltage signals correspond to a condition selected from the group consisting of the light beam being substantially unobstructed, the light beam being blocked by a substrate holder, and the light beam passing through the substrate.

19. An optical monitor for continuously monitoring layer thickness during thin film deposition of optical coatings, comprising in combination:
a laser diode operable to generate a monochromatic light beam with a wavelength of substantially 635 nanometers at substantially 3 milliwatts, wherein the monochromatic light beam is directed through a glass view-port with an adjustable mirror and towards an optical substrate located in a coating chamber;
a photodiode mounted inside the coating chamber using a mounting fixture, wherein the photodiode is operable to detect light and provide a current signal representative of an amount of light detected, and wherein the amount of light detected is related to thickness of thin film layers deposited on the optical substrate;
a control panel operable to convert the current signal into a voltage signal, thereby generating optical transmission data from the output of the photodiode; and
a computer operable to determine layer thickness using the optical transmission data obtained from the control panel, wherein the computer provides correction information for adjusting layer thickness.

20. An optical monitor for continuously monitoring layer thickness during thin film deposition of optical coatings, comprising in combination:
a laser diode operable to generate a monochromatic light beam with a wavelength of substantially 635 nanometers at substantially 3 milliwatts, wherein the monochromatic light beam is directed through a glass view-port with an adjustable mirror and towards a witness glass located in a coating chamber;
a photodiode mounted inside the coating chamber using a mounting fixture, whereby the photodiode is operable to detect light and provide a current signal representative of an amount of light detected, and wherein the amount of light detected is related to thickness of thin film layers deposited on the witness glass;
a control panel operable to convert the current signal into a voltage signal, thereby generating optical transmission data from the output of the photodiode; and
a computer operable to determine layer thickness using the optical transmission data obtained from the control panel, wherein the computer provides correction information for adjusting layer thickness.

21. A method of continuously monitoring layer thickness during thin film deposition of optical coatings, comprising in combination:
directing a light beam at an optical substrate in a coating chamber, wherein a thin film layer is deposited on the optical substrate;
detecting light from the light beam after it passes through the optical substrate, wherein an amount of light that passes through the optical substrate is representative of a thickness of the thin film layer; and
calculating the thickness of the thin film layer based on the amount of light detected.

22. The method of claim 21, further comprising providing correction information.

23. The method of claim 22, wherein the correction information is used to adjust the thickness of the thin film layer.

24. The method of claim 21, wherein the light beam is directed into the coating chamber through a glass view-port using an adjustable mirror.

25. The method of claim 21, wherein the light beam is monochromatic.

26. The method of claim 21, wherein a photodiode detects the light from the light beam after it passes through the optical substrate.

27. The method of claim 21, wherein the optical substrate is located on a substrate holder.

28. The method of claim 27, wherein the substrate holder is located in a planetary system.

29. The method of claim 28, wherein the planetary system provides single axis rotation in the coating chamber.

30. The method of claim 28, wherein the planetary system provides dual axis rotation in the coating chamber.

31. The method of claim 21, wherein the thickness is calculated after converting a current signal representative of the amount of light detected into a voltage signal.

32. A method of continuously monitoring layer thickness during thin film deposition of optical coatings, comprising in combination:
directing a light beam at a witness glass in a coating chamber, wherein a thin film layer is deposited on the witness glass;
detecting light from the light beam after it passes through the witness glass, wherein an amount of light that passes through the witness glass is representative of a thickness of the thin film layer; and
calculating the thickness of the thin film layer based on the amount of light detected.

33. The method of claim 32, further comprising providing correction information.

34. The method of claim 33, wherein the correction information is used to adjust the thickness of the thin film layer.

35. The method of claim 32, wherein the witness glass is located on a substrate holder.

36. The method of claim 35, wherein the substrate holder is located in a planetary system.

37. The method of claim 36, wherein the planetary system provides single axis rotation in the coating chamber.

38. The method of claim 36, wherein the planetary system provides dual axis rotation in the coating chamber.
